(19) United States
(12) Patent Application Publication
(10) Pub. No.: US 2015/0098129 A1
(43) Pub. Date: Apr. 9, 2015

(54) GENERATING MECHANICAL FEATURES ON AN OPTICAL COMPONENT

(71) Applicant: BAE Systems Oasys LLC, Nashua, NH (US)

(72) Inventor: Michael Couture, Litchfield, NH (US)

(73) Assignee: BAE Systems Oasys LLC, Nashua, NH (US)

(21) Appl. No.: 14/261,676

(22) Filed: Apr. 25, 2014

Related U.S. Application Data
(60) Provisional application No. 61/886,703, filed on Oct. 4, 2013.

(51) Int. Cl. G02B 7/02; G02B 13/00

(52) U.S. Cl. CPC G02B 7/021; G02B 13/001
USPC 359/503; 359/819

(57) ABSTRACT

A system and method for focusing electromagnetic radiation is presented. A lens has an outside perimeter. A curved lens surface is located inside the outside perimeter. The curved lens surface is to bend at least one wavelength of electromagnetic energy passing through the curved surface. One (or more) mounting surface(s) are located between the outer perimeter and the curved lens surface. The mounting surface has at least one flat surface.

### CROSS REFERENCE TO RELATED APPLICATION

This application claims priority from U.S. Provisional Application Ser. No. 61/886,703, filed Oct. 4, 2013; the disclosure of which is incorporated herein by reference.

### BACKGROUND OF THE INVENTION

1. Field of Invention

The current invention relates generally to apparatus, systems and methods for optical systems. More particularly, the apparatus, systems and methods relate to mounting optical components. Specifically, the apparatus, systems and methods provide for creating mechanical features on optical components such as lenses, for example.

2. Description of Related Art

The field of optical fabrication covers the manufacture of optical elements, typically from glass, but also from other materials. Glass is used for nearly all optical elements because it is highly stable and transparent for light in the visible range of wavelengths. Glass optics are economically manufactured to high quality in large quantities. Glass also can be processed to give a nearly perfect surface, which transmits light with minimal wave front degradation or scattering.

Additional materials besides glass are also used for optics. Plastic optics have become increasingly common for small lenses (<25 mm) and for irregular optics with reduced accuracy requirements. Metal mirrors are used for applications with stringent dynamic requirements or thermal loading. Optics made from crystals are used for special purpose lenses and prisms.

The optical engineer who is specifying the optical elements needs to understand how the size and quantity affect the manufacturing process, quality, and cost. Special tooling is required for large and difficult parts, which drives the cost up. However, special tooling can also lead to an efficient process, reducing the per-item cost for parts made in large quantities. Like any industrial process, optical fabrication has significant economies of scale, meaning that items can be mass-produced more efficiently than they can be made one at a time. There is always a tradeoff between improved efficiency and tooling costs. (“Tooling” refers to any special equipment used for manufacturing an item. Tooling is not used up in the process, so it can be used repeatedly). If only a few elements are needed, it does not make sense to spend more on tooling than it would cost to make the parts by a less efficient method.

The most difficult aspect for many optical components comes from the tight tolerances specified for optics. The optical system engineer must assign specifications that balance performance with fabrication costs. The tolerances must be tight enough to assure acceptable system performance, yet not so tight that the parts cannot be made economically. For a particular project, the fabrication process is usually selected to achieve the specified tolerances. Parts with tighter requirements are nearly always more expensive and take longer.

As the trend to minimize size, weight, and power in military imaging systems continues, designs must meet performance requirements with fewer lens elements. Conventional machining uses lens spacers that can often make control of the airspace difficult on steep surfaces and may not allow for easy control of lens tilt. What is needed is a better optical system.

### SUMMARY

One aspect of an embodiment of the invention may include a system and method for focusing electromagnetic radiation. A lens has an outside perimeter. A curved lens surface is located inside the outside perimeter. The curved lens surface is to bend at least one wavelength of electromagnetic energy passing through the curved surface. One (or more) mounting surface(s) are located between the outside perimeter and the curved lens surface. The mounting surface has at least one flat surface.

In one aspect the invention, another embodiment may provide for an optical system that includes a first lens with a first flat surface as well as a second lens with a second flat surface. The optical system can further include a spacer with a first flat surface and a second flat surface. The first flat surface of the first lens presses against the first flat surface of the spacer and the second flat surface of the second lens presses against the second flat surface of the spacer.

Another aspect of the invention can be a method of building an optical device that includes a physical mounting structure and an optical surface on the same piece of material. The method begins by fabricating an optical surface on a material. The optical surface is to later bend at least one electromagnetic waveform passing through the optical surface. A physical mounting structure with at least one flat surface is also fabricating on the material. The physical mounting structure allows the material to be mounted in an optical system using the flat surface(s).

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates how prior art lenses were mounted in an optical system.

FIG. 2 illustrates a preferred embodiment of a novel way to produce physical mounting features in two lenses and mount them together.

FIG. 3 illustrates details of the example mounting features of FIG. 2.

FIG. 4A illustrates an example side view of a diamond cutting system that can be used to cut novel mechanical mounting features in a lens.

FIG. 4B illustrates an example top view of a lens on the a diamond cutting system that can be used to cut novel mechanical mounting features in a lens.

FIG. 5 illustrates an example embodiment of a method for mounting lenses with mechanical features built into them. Similar numbers refer to similar parts throughout the drawings.

### DETAILED DESCRIPTION

FIG. 1 illustrates a prior art lens system 1. It includes two lenses 3A-B separated by two spacers 5A-B. Alternatively, the spacers 5A-B could be a single cylindrical spacer; however, for ease of explanation, two spacers 5A-B will be discussed. Lens 3A has a flat upper surface 10 and a curved lower surface 11 while lens 3B has a curved upper surface 12 as well as a curved lower surface 14. Because the spacers 5A-B must be placed between the lower curved surface 11 of lens 3A and the upper curved surface 12 of lens 3B, they are difficult to fabricate with tight physical tolerances. This is because it is hard to create curved surfaces on the spacers 5A-B in exactly the same shape as the corresponding curved surfaces of the lenses 3A-B.

Very simple optical designs can provide excellent nominal performance, but can make definition of a good tolerance budget very difficult. Very high sensitivities require very tight tolerances to maintain good performance for the as-built hardware. However, as discussed above with reference to FIG. 1, it is very challenging to create highly accurate spacers 5A-B with very tight tolerances because of their curved top 7A-B and curved bottom 9A-B surfaces. Understanding that diamond turning equipment is, for example, essentially an extreme precision CNC lathe, it can be envisioned how tolerances that would be extremely challenging to hold in a conventional machine shop are able to be held in a diamond turning process. By diamond turning novel features into the lens itself, a spacer with square edges can be used.

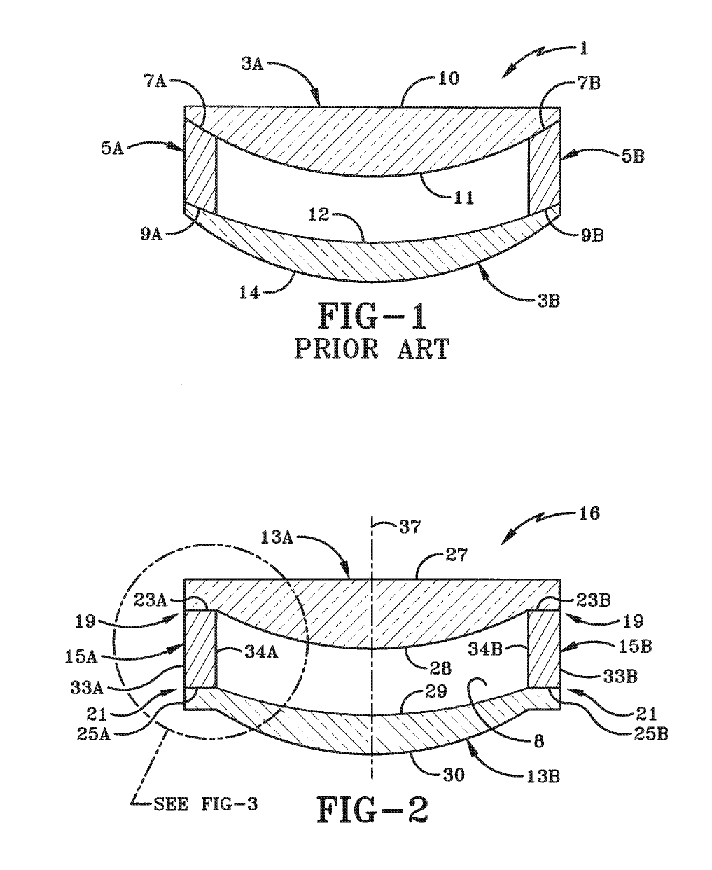

As illustrated in FIG. 2, by fabricating lens 13A-B with mechanical features in them, it is possible to easily manufacture very simple spacers 15A-B to be used to separate the lenses 13A-B. While two spacers are discussed, a single simple cylindrical spacer could be used to replace them. Spacers 15A-B are easier to manufacture and measure making control of airspaces between lenses 13A-B easier. Additionally, the lens shoulder is machined at the same time as the optical surfaces, thereby providing for surfaces that are extremely perpendicular and centered relative to an optical axis 37.

The optical system 16 of FIG. 2 has two lenses 13A-B and two spacers 15A-B, similar to those of FIG. 1. The first lens 13A has spaced apart flat and curved surfaces 27, 28 while the second lens 13B has two spaced apart curved surfaces 29, 30. In general, air 8 fills the space between the lenses 13A-B but in other configurations, other materials may fill the space between them. In the preferred embodiment, the lenses 13A-B are formed out of glass, plastic or crystals but in other embodiments they can be formed with other materials.

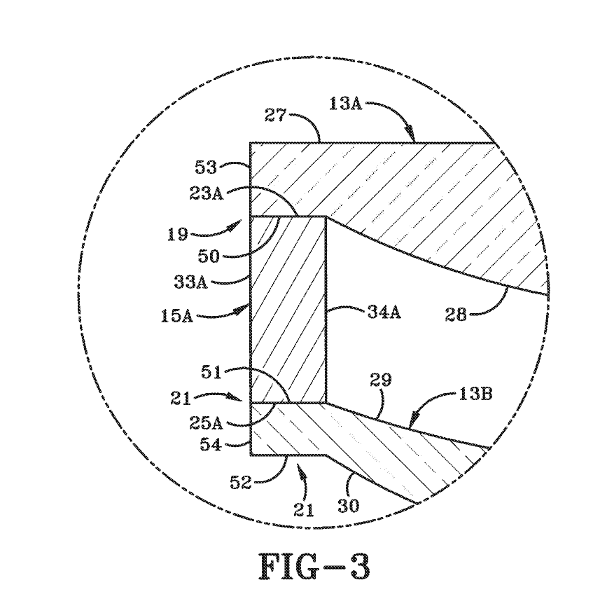

One novel aspect of the preferred embodiment is the mechanical features 19, 21 (e.g., physical mounting features) are built into the lenses 13A-B. As best seen in FIG. 3, the lens 13A and mechanical features 19, 21 have been formed with a flat surface 50 that is parallel to the flat surface 27 until it reaches curved surface 28. Somewhat similarly, lens 13B is formed with flat surfaces 51, 52 that are both parallel to surfaces 27 and 50 of lens 13A. Lens 13A is formed with a side surface 53 that is perpendicular and 90 degrees with respect to surfaces 27 and 50. Similarly, Lens 13B is formed with a side surface 54 that is perpendicular and 90 degrees with respect to surfaces 51 and 52. Even though FIG. 3 illustrates spacer 15A, spacer 15B can also have similar features.

As illustrated, the lens surfaces 28, 29 can be curved until they reach the spacers 15A-B. The mechanical features 19, 21 formed on the lenses 13A-B, the spacer(s) 15A-B used to separate them have flat top surfaces 23A-B and flat bottom surfaces 25A-B. These flat surfaces provide for the spacers separating to take advantage of these flat surfaces. Because the spacers 15A-B have flat top surfaces 23A-B, flat bottom surfaces 25A-B, flat outside surfaces 33A-B, and flat inside surfaces 34A-B, they are much easier to produce than the curved prior art spacers of FIG. 1. Notice that the top surface 23A of the spacer 15A, the bottom surface 25A, the outside surface 33A and the inside surface 34A form a cross-section that is rectangular in shape. Similarly, spacer 15B has a top surface 23B, a bottom surface 25B, an outside surface 33B and an inside surface 34B that form a cross-section that is also rectangular in shape. Spacers that have a rectangular cross-section are much easier to manufacture and allow for tighter tolerances than prior art spacers that had cross-sections with curved surfaces because mechanical features were not machined into the lenses they were mounted to.

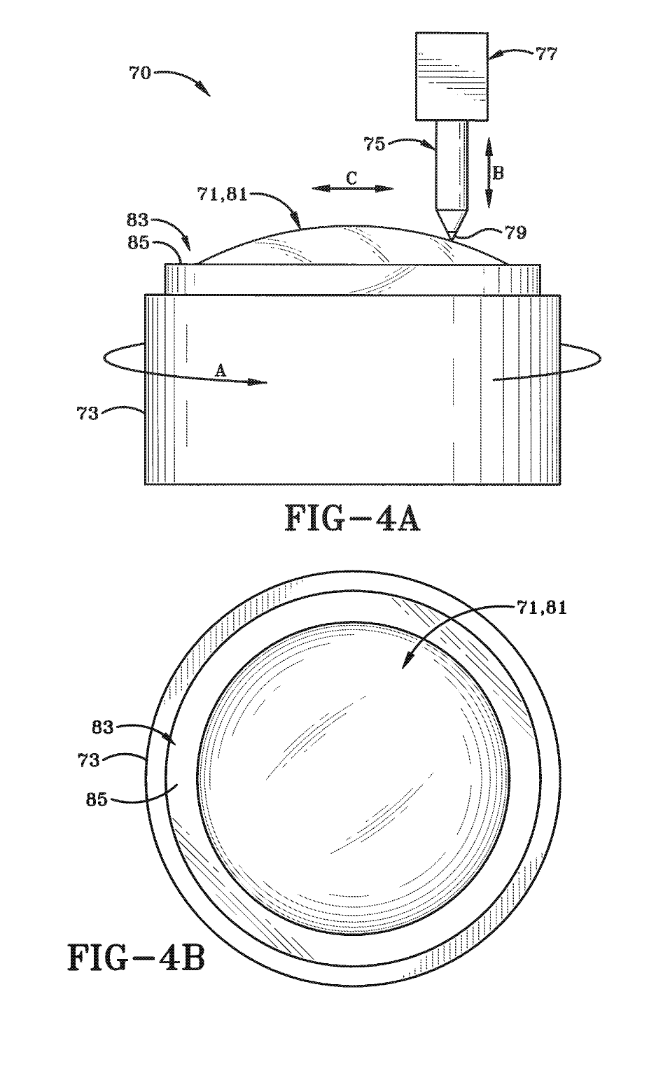

FIGS. 4A-B illustrated an example diamond cutting system 70 that is used to cut a material into an optical component 71 that includes a lens and that also includes mechanical/mounting features cut into that same material. While these figures illustrate an example diamond cutting system 70, those of ordinary skill in the art will appreciate that any high precision cutting system could be used. The material to become the optical component is mounted to a lens mount 73 that rotates/spins in the direction of arrow A. The lens mount 73 is designed to spin with essential no wobble or only a few millionths of an inch of wobble.

This example diamond cutting tool has a cutting shank 75 positioned above the optical component 71. The cutting shank 75 is positioned in a shank control mechanism 77 that moves the shank 75 up and down in the directions of arrows B and C. A diamond cutting device 79 is attached to the lower end of the cutting shank 75. The diamond cutting device 79 cuts the optical component 71 into a convex lens 81 that will includes mechanical features 83 while it is spun by the lens mount 73 spins the optical component. In this illustration, the mechanical feature is a flat cylindrical mounting surface 85 that can later be used with a simple cylindrical spacer to mount this lens 81 in an optical system with a high degree of precision.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

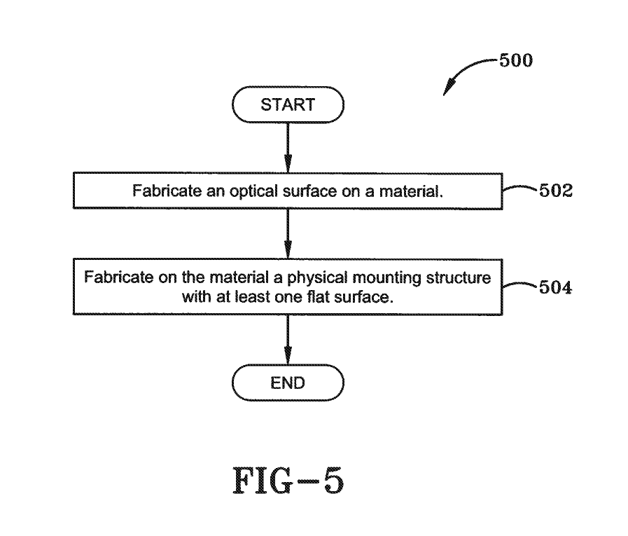

FIG. 5 illustrates a method 500 of producing an optical device. The method begins, at 502, by fabricating an optical surface on a material. The optical surface is to later bend at least one electromagnetic waveform passing through the optical surface. For example, the optical surface can be a convex surface and can be cut into the material using a diamond cutting tool as discussed above. A physical mounting structure that includes a flat surface is fabricating on the material, at 504. Unlike prior art lenses, this mounting structure is fabricated with the optical surface and flat surface of the physical mounting structure on the same piece of material. In some configurations, physical mounting structure can be fabricated on an outer perimeter of the material.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A lens comprising:
an outside perimeter of the lens;
a curved lens surface inside the outside perimeter, wherein the curved lens surface is to bend at least one wavelength of electromagnetic energy passing through the curved surface; and
one or more mounting surfaces located between the outer perimeter and the curved lens surface, wherein the one or more mounting surfaces have at least one flat surface.

2. The lens of claim 1 wherein the one or more mounting surfaces further comprise:
a side surface; and a
flat bottom surface adjacent the side surface.

3. The lens of claim 2 wherein the flat bottom surface is circular in shape.

4. The lens of claim 3 further comprising:
a spacer device that is cylindrical in shape and configured to space the lens apart from another optical element in an optical structure.

5. The lens of claim 2 wherein the spacer device further comprises:
at least one end that is planar, and wherein the at least one end that is planar rests on the flat bottom surface of the one or more mounting surfaces.

6. The lens of claim 1 wherein the outer perimeter is round.

7. The lens of claim 1 wherein the curved surface is a convex curved surface.

8. The lens of claim 1 wherein the lens is fabricated out of at least one of the group of: glass and plastic.

9. An optical system comprising:
a first lens with a first flat surface;
a second lens with a second flat surface; and
a spacer with a first flat surface and a second flat surface, wherein the first flat surface of the first lens presses against the first flat surface of the spacer, and wherein the second flat surface of the second lens presses against the second flat surface of the spacer.

10. The optical system of 9 wherein the spacer is a cylinder that is cylindrical in shape.

11. The optical system of 10 where the cylinder further comprises:
a top end wherein the first flat surface of the spacer is located at the top end; and
a bottom end wherein the second flat surface of the spacer is located at the bottom end.

12. The optical system of 9 wherein the first lens further comprises:
a first perimeter, and wherein the second lens further comprises:
a second outer perimeter, and wherein the spacer is located between the first perimeter and the second perimeter.

13. The optical system of 9 wherein the spacer further comprises:
a top surface;
a bottom surface;
an outside surface; and
an inside surface, and wherein a cross-section of the spacer is rectangular in shape.

14. The optical system of 9 wherein the second lens with the second flat surface further comprises:
a flat vertical surface; and
a flat bottom surface that is rotated 90 degrees with respect to the flat vertical surface.

15. The optical system of 9 wherein the first lens further comprises:
two different flat surfaces formed at an angle, a, between the two different flat surfaces.

16. A method of producing an optical device comprising:
fabricating an optical surface on a material, wherein the optical surface is to later bend at least one electromagnetic waveform passing through the optical surface; and
fabricating on the material, a physical mounting structure with at least one flat surface so that the material can be mounted in an optical system using the at least one flat surface.

17. The method of claim 16 wherein the machining the physical mounting structure further comprises:
machining the physical mounting structure using a diamond cutting tool.

18. The method of claim 16 further comprising:
machining the physical mounting structure on an outer perimeter of the material.

19. The method of claim 16 further comprising:
machining the physical mounting structure to include a first planar surface and a second planar surface, wherein the first planar surface is at an angle of about 90 degrees to the second planar surface.

20. The method of claim 16 wherein the fabricating an optical surface further comprises:
fabricating an optical surface that is a convex optical surface.
